(19) United States
(12) Patent Application Publication
(10) Pub. No.: US 2020/0258118 A1
(43) Pub. Date: Aug. 13, 2020

(54) Correlating multi-dimensional data to extract & associate unique identifiers for analytics insights, monetization, QOE & Orchestration

(71) Applicants: Surya Kumar Kovvali, Westborough, MA (US); Shreerang Shastri, Reading, MA (US); John Hutchins, Groton, MA (US)

(72) Inventors: Surya Kumar Kovvali, Westborough, MA (US); Shreerang Shastri, Reading, MA (US); John Hutchins, Groton, MA (US)

(21) Appl. No.: 16/271,855

(22) Filed: Feb. 10, 2019

(51) Int. Cl. G06Q 30/02; H04L 29/08; H04L 12/26

(52) U.S. Cl. CPC G06Q 30/0251; H04L 43/026; H04L 67/306

(57) ABSTRACT

Data collection system that receives plurality of user network data access flows that include HTTP/HTTPS URLs from network probes or network elements such as CDNs, Proxies, control plane logs (S11, SlAP etc.) that include permanent subscriber identifier (IMSI, IMEI) or obfuscated subscriber identifiers, or obtains such identifiers corresponding to user IP addresses in access flows from operator network elements, extracts plurality of unique identifiers (UUIDs), plurality of tags, or contextual identifiers that appear in URL strings, determines domain names from HTTP/HTTPS header fields or temporally close DNS flows and generates a mapping table that includes subscriber identifiers, domain names, HTTP tags, and associates subset of UUIDs as potential Advertisement Identifier (Ad-Id) for each subscriber-id based on the usage counts of that UUID across multiple domains.

### CROSS REFERENCE TO RELATED APPLICATION

This patent application claims priority to and benefit of the filing date of U.S. Provisional Patent Application No. 62/710,212, entitled “Correlating Multi-Dimensional Data to Extract & Associate Unique Identifiers for Analytics Insights, Monetization, QOE & Orchestration” filed Mar. 15, 2018, the entire disclosure of which is hereby incorporated herein by reference.

### 1. INTRODUCTION

Extraction of unique identifiers such as mobile device advertisement identifier, mobile application identifier, Publisher identifiers used by CDN or cloud providers, session identifier etc., and association of these identifiers with a subscriber identifier (operator IMSI or IMEI), device-type & application from data collected and co-related from multiple sources within the Operator network such as user plane network traffic, control plane network traffic, flow-logs from operator network devices (web server, transit web-cache/proxy, GGSN/PGW, Packet Probe/DPI devices, RADIUS Server), subscription/service plan data is the subject matter of the current invention.

Further, the current invention uses self-learning and auto-tuning to learn, validate, discard and update the identifiers associated with semi-permanent entities (subscriber, site, application etc.), thus maintaining the accuracy of the identifiers associated with the semi-permanent entities on a continuous basis. Additionally, the invention computes a confidence level for each identifier associated with a semi-permanent entity. The confidence level facilitates the receiving system that receives these identifiers & corresponding associations to use its own methods (outside of the scope of current invention) to pick and apply the best identifier suitable for its application.

The Identifier association with semi-permanent entities (subscriber, web-site, application etc.) is made available to consuming or receiving systems for applications including but not limited to monetization of data by advertisements, sponsored data, service plan promotions, monitoring/usage reports, content selection and delivery, QOE optimizations via APIs and/or pre-defined formatted files.

### 2. REFERENCES

2.1. A Universally Unique Identifier (UUID) URN Namespace, RFC 4122
2.2. Domain Name Resolution, U.S. Pat. No. 9,426,049, Jan. 6, 2014
2.3. System and method for collecting, reporting and analyzing data on application-level activity and other user information on a mobile data network, U.S. Pat. No. 8,108,517, Jan. 31, 2012
2.4. Transport Layer Security (TLS) Extensions, RFC 6066
2.5. QUIC: A UDP-Based Secure and Reliable Transport for HTTP/2, draft-tsvwg-quic-protocol-02

### 3. TERMINOLOGY

| S. No | Term | Description |
|---|---|---|
| 1 | User Flow | A transaction from a mobile device to an internet |
| | | server using any of the well- known protocols |
| | | like HTTP, HTTPs/TLS. |
| 2 | Publisher | Entity serving content on the internet (e.g. CNN) |
| 3. | Advertiser | Advertising server that serves Ads to Publisher |
| | | pages on the internet (E.g. Google DoubleClick) |
| 4 | CON | Content Delivery Network used by Publishers to |
| | | deliver content (e.g. Akamai, Lightspeed or |
| | | Edgesuite) |
| 5 | Appstore | An appstore is a special Publisher who hosts an |
| | | application store and enables subscribers to download |
| | | mobile applications (E.g Google Play, iTunes) |
| 6 | Key Entity | Key identifiers such as subscriber-ID (IMSI), domain/ |
| | (KE) | site name, FQDN, Application ID, session ID that |
| | | remain constant for long periods of time, and they |
| | | serve as key in that name space - for example a |
| | | subsriber's IMSI as an identity of subscriber |
| 7 | UUID | Globally Unique identifier with format as defined in |
| | | RFC 4022 |
| 8 | UID | Unique identifier in a specific context, for example, |
| | | application identifier values are unique within i-phone |
| | | applications and may have one format and different |
| | | from values in android applications. Thus, the scope of |
| | | UID is relevant to class of applications. |
| 9 | ADID | Advertisement Identifier; in some devices it is called |
| | | IDFA |
| 10 | Appld | Application Identifier; unique identifier that |
| | | corresponds to that application on that device & |
| | | app-store; thus, the format and scope of AppId could |
| | | be different on different types of devices and |
| | | AppStores |
| 11 | Publisher, | Website, domain that the domain belongs to |
| | Brand | |

### 4. BACKGROUND

Identifiers such as subscriber-id (IMSI, MS-ISDN) that are useful in categorizing user demographics, browsing patterns etc., are very useful for Advertisers to sell targeted advertisement. Many of the service providers on the internet, such as Mail Service, YouTube etc., that offer free services get revenues by selling advertisements when their service is used by a subscriber. However, making subscriber identifiers visible on the internet violates user's privacy, since the permanent subscriber identifier such as IMSI, phone number etc., has significant subscriber information throughout the internet and many businesses. Thus, mobile device vendors such as Apple, Google etc., assign their own relatively dynamic identifiers that correspond to a subscriber for longer periods; such IDs are resettable by subscriber and/or device vendor. Apple calls them as “IDFA”, whereas Google calls them as ADIDs in their devices. These are termed as “ADIDs”, in the current invention. Thus, the scope of such identifier is the device vendor, and specific Device/OS/Application releases. Thus, Apple's IDFAs are independent of Google's ADIDs and these identifiers are limited in scope thus overcoming issues with privacy protection. Additionally, an application vendor such as Google that sells applications to both i-phones, and android phones could use ADID's, when their applications are active—thus a device such as I-phone may have both IDFA and ADID. Learning ADIDs associated with a more permanent subscriber such IMSI from the traffic exchanged through the mobile network by developing insights and generating a learning algorithm is one of the key subject matters of the current invention.

Similar to ADID, app store vendors such as “I-Tunes”, Google “AppStore”, use identifiers that are unique in their Appstore to uniquely identify an application; app vendors communicate this identifier while communicating through the internet. Identifying the app-id in the device communication facilitates the context of the application for traffic to/from the device in a given period of time. While every packet to or from the device may not have the specific app-id in clear (without encryption), identifying up/down packets in a given period and associating with an app-id, facilitates characterizing the specific behavior, detecting anomalies, behavior changes newer version are released, observing and predicting usage patterns facilitates a number of benefits to mobile operators, device & application vendors. Additionally, devices typically contain generic application such as a browser that facilitates searching, and/or reaching web-sites without requiring download of native applications to access websites. Also, many websites may not have a unique client application and reachable via http or https or other protocols using SAFARI, FIREFOX, Internet Explorer, Chrome etc., browsers using W3C semantics. Identifying and separating traffic from browser (along with specific browser) vs non-browser (any native app) from learning insights of browser access patterns, and information contained in the packet exchanges is another embodiment of the current invention.

Identifying other unique identifiers for specific use, such as, cloud-id, CD N-ID, that are assigned by a specific service provider, and associating with the corresponding clients are additional embodiments of the current invention.

Identifiers on the internet come in variety of compositions and lengths. Most commonly used identifiers on the internet are UUIDs as defined in RFC-4122 which are 32-Hex Characters long and take one of the following forms:
1. Version 1 (Time/node based): xxxxxxxx-xxxx-1xxx-Rxxx-xxxxxxxx
2. Version4(random): xxxxxxxx-xxxx-4xxx-Rxxx-xxxxxxxx
   Where R is one of 8, 9, A or Band every “x” is a hexadecimal character. These characters including R could be uppercase or lowercase.

Mobile Advertisers use UUIDs for tracking and delivering targeted mobile advertisements to mobile devices—both phones and tablets. Such UUIDs compliant with RFC-4122 are referred sometimes with different names depending on their usage, for example, as IDFA on Apple Devices and ADID on Android Devices. Collectively, IDFA and ADID, are referred to as “Ad-Id” in this document. Such Ad-Ids are used by one or more applications while requesting mobile advertisements so that the Publisher's application server can use it to either request server-side ads and embed the mobile Ad content within the content it serves or forward it to a third-party Ad-Manager to serve a targeted Ads.

Similar to Ad-Ids, App stores like iTunes and Google Play use java package names or Appstore specific identifiers to identify and track individual mobile applications and their versions downloaded by subscribers. Such Appstore identifiers are referred to as “App-Id” in this document.

Similarly, CDN (Content Delivery Networks) and Cloud providers use their own scheme of identifiers to identify the Content Publishers whose content is cached or prefetched or hosted and delivered from their network s. Such ids are referred to as “Cloud-Id” in this document. These identifiers may or may not be globally unique and may not use the RFC4122 format, since they need to be unique in their own domains.

It is important to note that while the “unique identifiers in the current invention” refers to the Universally Unique identifiers per RFC4122, the invention is equally applicable to unique ids used by a website or app-store, cloud environment etc., with a form defined by that provider to identify distinct clients, apps, sites etc.

Current invention extracts Ad-IDs, App-Ids, Cloud-Ids etc., from correlated multi-dimensional data, and where applicable, classifies them based on behavioral category of servers receiving or transmitting these on the internet, associates these Ids to individual subscribers (or apps or sites) in near Real-Time and automatically re-associates these Ids to the corresponding “Key Entities” (KE) even if and when the device user or server update the Ids.

All user flows containing Ad-Ids, App-Ids, Cloud-Ids etc., are communicated between the subscriber's mobile device and the Publisher server (Appstore/Advertiser) either via HTTP or encrypted protocols including but not limited to HTTPS/TLS. When these Ids are communicated using encrypted protocols such as HTTPS/TLS, the App-Ids or Ad-Ids are not directly visible to the transit network device or a packet capture/DPI device and cannot be observed or extract ed. Extraction and Identification of Ad-Ids, App-Ids and Cloud-Ids from encrypted user flows is outside the scope of the current invention. However, the ID exchanged by user device within the encrypted protocol, may appear in other exchanges to/from the user device without encryption with other keywords or tags in other protocols such as HTTP; identifying these and associating them with Key Entities (KEs) is one of the subject matters of the current invention.

### 5. EMBODIMENTS OF THE CURRENT INVENTION

1. ADID/IDFA Mapping to Subscriber-ID (IMSI or Obfuscated IMSI or MSISDN): From URL/Click-stream user plane data collected from a DPI device in the operator network, or HTTP, HTTPS, DNS, VOLTE logs, extract plurality of unique identifiers and associate them with network-wide mobile subscriber ID (IMSI). Such correlated information is made available via APIs for mapping of one or more unique identifiers of a specific type (for example ADID) corresponding to a subscriber (IMSI). Alternatively, the subscriber ID for a specific unique identifier type (for example unique ADID could be determined.
2. Identifying browser vs. app accesses: When a mobile device communicates with servers on the internet (cloud, origin server or CON), the application on the device may be bowser (Safari, Firefox, Internet Explorer, Chrome et c.), or a native application that is downloaded and running on the device. Applications may also use HTTP or HTTPS protocol and may not be distinguishable based on HTTP/HTTPS port numbers alone. The invention uses access patterns from multiple users while accessing the site or a single user accessing multiple sites during the same session. The access patterns include number of simultaneous TCP connections to the same web-site, multiple tcp connections from the same user device to multiple servers, user-agent string etc. While the user agent-string may correspond to a user application, several applications use popular http client software, and thus use same user agent string. Methods of observing access patterns from single user to multiple sites, multiple users of the same device class to multiple sites, and multiple devices to the same site to distinguish between browser accesses and native application accesses are identified in the current invention.
3. App-ID Correlation to App-Store, Device-Type, Application Server Name—The APPIDs are unique to an Appstore. For example, iTunes uses its own proprietary Id scheme to identify each of the applications or their upgrades that is different from App-Ids used by Google's Google Play Appstore. Such App-Ids may not be RFC4122 compliant. After browser accesses are differentiated from native app accesses, Identifying App-Ids from native-app user flows facilitates characterizing application behavior, network usage behaviors on specific device type & software releases.
4. Cloud ID—For cloud hosted or CDN, majority of Domain names, IP addresses, URLs used to deliver content to the mobile device refer to cloud provider instead of the Publisher. In turn, the Cloud provider or CDN uses it's own unique ID scheme to deliver content for each of its clients. Identifying the cloud provider and associated unique id for each content provider/web-site facilitates characterizing subscriber usage/behavior and quantifying it effectively with KPIs. Specific use-cases for each of the above Ids are described in, “Use Cases” section.

### 6. THEORY OF OPERATION

This section provides a detailed description of the invention and underlying mechanisms for extracting and identifying the Identifiers from multiple streams of data.

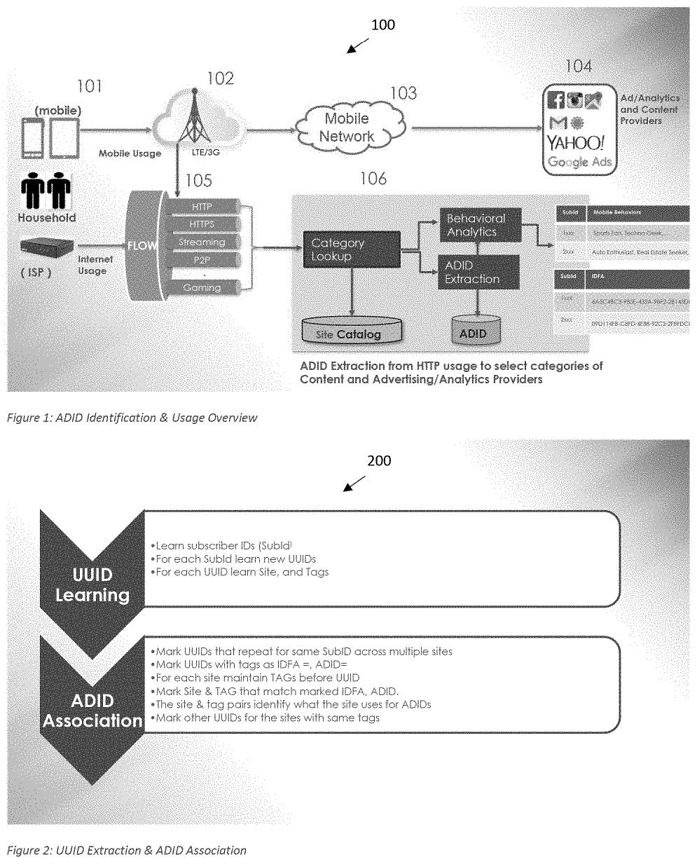

FIG. 1, 100 is an outline of ADID identification method and it's usage. The traffic from mobile devices 101 is received by LTE/3G eNB or RNC that is transmitted to/from Websites/Ad/Analytics Servers 104 via the Mobile Network 103. A copy of the traffic flows from the eNB, along with user plane data traffic 105 is received and analyzed by decoding corresponding protocols. The analytics system 106 performs category lookup into the Site Catalog.

FIG. 2, 200 outlines learning UUIDs, associated tags and domains for each subscriber ID (SUBID) from HTTP URL flows; learning converts all characters to upper case and converts escape sequences to corresponding symbols. As new UUIDs are received, UUIDs with tag “IDFA=” or “ADID=” are marked as potential ADIDs for the SUBID. The tags are site and device application specific. As a UUID is received that matches an already identified ADID, the associated tags, domain name are recorded as potential ADID tags for that website. If new UUIDs are received from other subscribers (SUBIDs), they are marked as potential ADIDs. Thus, the site name-tag values grow and help to improve ADID identification.

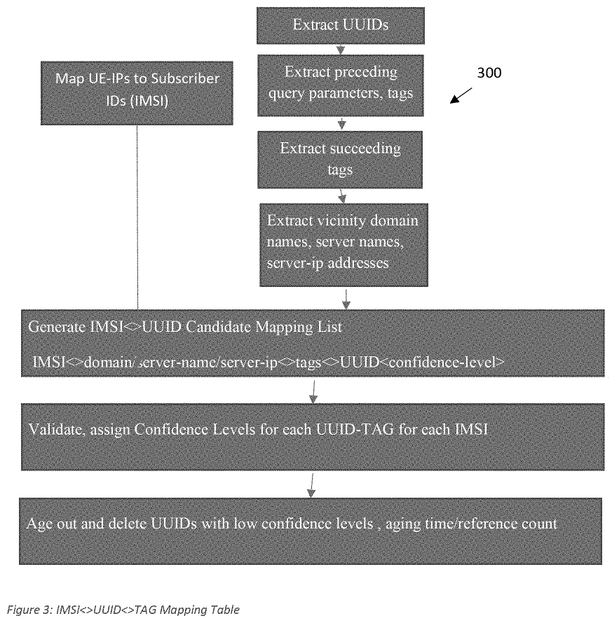

FIG. 3, 300 describes the steps in detail. The confidence levels for UUID is increased if the same UUID appears for the same subscriber across multiple domains/sites.

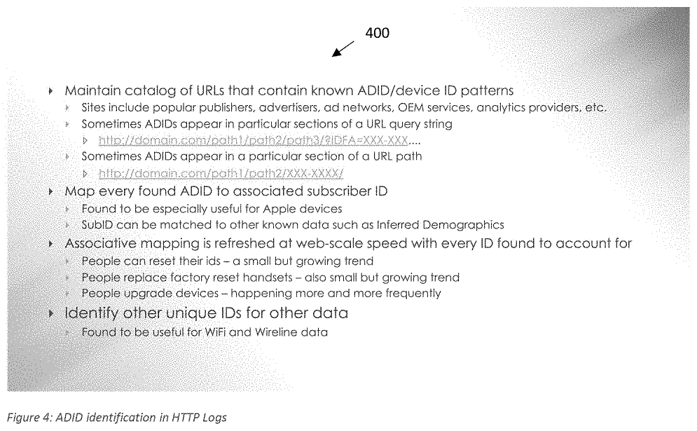

FIG. 4, 400 details the ADID identification and it's usage to map to subscriber demographics by associating ADID to SUBID, and tracking URL categories per each SUBID. The steps also show different formats that ADIDs appear with query string or in URL path.

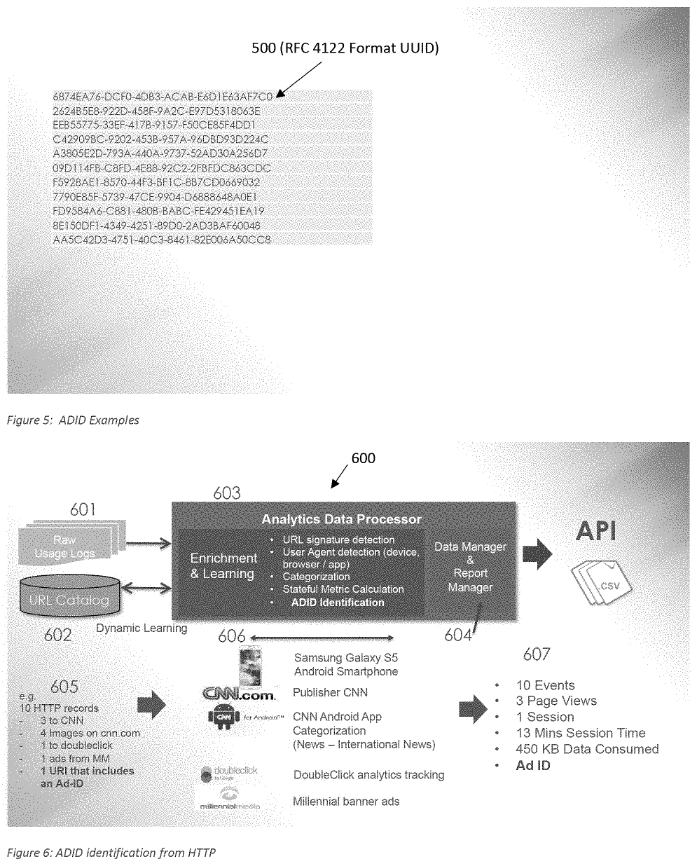

FIG. 5, 500 shows example ADIDS in RFC4122 UUID format.

FIG. 6, 600 outlines dynamic learning by Analytics Data Processor (ADP) from RAW usage logs 601 and URL Catalog 602; the ADP 603 classifies new URLs by matching keywords from FQDNs, web-crawling and keyword usage. The data & report manager 604 generates mapping table for user-initiated queries via API, and also generates a CSV file to export to other operator devices. ADP 600 receives user flow data 605 such as HTTP records, extracts publisher names, device identifiers etc., 606 and generates summary information 607 that includes events, page views, session time, AdID etc., for each session for every subscriber.

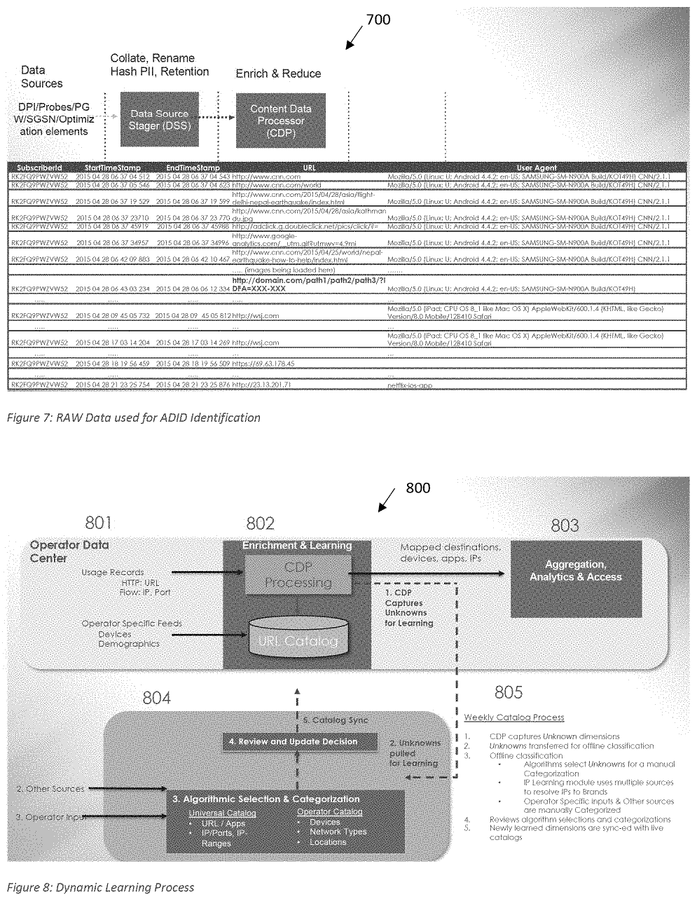

FIG. 7, 700 outlines alternative data feeds to the Data Source Stager (DSS), that organizes data and feeds to the Content Data Processor (CDP), which retains needed information, and enriches by association.

FIG. 8,800 is functional block diagram of URL Catalog generation process in which CDP receives subscriber usage records that contains URLs. The CDP 802 receives multiple feeds from operator data center 801, extracts key information such publisher/domain names, UUIDs, subscriber identifiers, looks up URL catalog for already learned domains, and exports unknown entries for manual/offline classification and learning 804. The manual/offline process 805 weekly updates the URL catalogue by manually accessing web-site/domain of unknown entries to determine categories and sub categories.

UUID Extraction—When determining a particular UUID that matches the RFC 4122 pattern, the following aspects need be considered:
1. Generally, most internet applications use a form of UUID to identify, track and tailor their content or application behavior to meet device users' needs. As an example, an application store may use a form of UUID to identify and track the applications the user downloads. This UUID is different from the Ad-Id used by those downloaded applications for requesting and displaying mobile advertisements. Current invention goes further to isolate the ADIDs used by mobile advertising applications by investigating the internet Publishers or servers transmitting or receiving the UUID for category of content typically transmitted by those Publishers or servers.
2. An Ad-Id associated with a user device may be updated by the user at any time. When the Ad-Id is updated, both the old id and new id may be used or transmitted either by the device or the associated application on the internet, possibly for multiple days. Thus, a user's device may be mapped to multiple Ad-Ids for a short period (e.g. 1-3 days). It is expected as the number of days increase, old ad-ids are phased out and the ecosystem transitions to the user's updated Ad-Id.
3. Communication between a Device and application servers on the Internet via a mobile application or browser may either use unencrypted protocol like HTTP that facilitate parsing and identification of HTTP headers or may use encrypted protocols such as HTTPS or TLS which make parsing of protocol headers impossible. Extracting Ad-Ids from encrypted protocol transactions like HTTPS/TLS is outside the scope of the current invention methods. The invention identifies that while the AD-ID may be exchanged in encrypted in communication with a specific website or server (for example app site), the same ID may be passed on in other un-encrypted communications to or from the device. Thus, an Identifier that is unique and appears with the same subscriber over a period of time in multiple sessions is potentially an AD-ID.

In general, a device may communicate with certain domains/sites/web-pages on the internet with or without encrypted protocols in varying pro port ions. Since current invention does not attempt to decrypt the traffic to extract or identify an Ad-Id from the encrypted traffic, the system takes varying amount of time to extract, verify and assign an Ad-Id to a subscriber. As each subscriber's ad-ids is learned per the current invention methods, the number of subscribers with unknown Ad-Ids decreases with time. While the system does not decrypt traffic from encrypted protocols such as HTTPS, it uses un-encrypted content of such protocols (for example during initial exchanges while establishing secure tunnels), or contextual or temporal association (e.g., DNS prior to HTTPS connection, HTTP content from the same user IP address during encrypted content exchanges) between encrypted and un-encrypted protocols.

The steps involved in identifying Ad-Ids, App-Ids and Cloud—Ids are outlined below. Steps 1-3 are common to extraction of Ids from multi-dimensional data whereas the remaining steps are specific to a class of IDs:
1. Map user IP addresses to subscriber ID (IMSI): All the user traffic from a capturing device, or from a log device contains user IP address (UEIP). Majority of UEIPs are dynamically assigned by the operator network. Thus the UEIP need to be mapped to permanent subscriber ID such as (IMSI or IMEI); such association may be done by cross correlation between control plane and user plane protocols[1,2], or such mapping is already done by the capturing & logging device. These methods are known in prior-art and outside the scope of current invention.
2. Extract 32 Hex character UUID pattern (RFC4122) from un-encrypted user flows: While extracting the comparison of characters is case incentive—so convert all characters to upper or lower case. The 32 Hex character together with separating hyphens [RFC4122] may be preceded by“=”,“&” etc., non-Hex Characters and succeeded by additional Hex Characters or other alpha numeric characters. Additionally the non-alpha numeric characters such as“=”,“&” may be specified as Hex code with HTTP Escape character “%”, for example 11 11 may appear as “%2D”. Thus before extracting UUIDs, and “TAG” strings, the escape characters are converted to actual symbol; for example, %2D is replaced with “−”, and %3D is replaced with “=”.
3. Identify server IP addresses or server names for a set of user flows—For HTTP flows, the server names or IP addresses are identified by decoding HTTP headers. If the content uses HTTPS, TLS or QUIK protocols where the URL etc. headers are encrypted, identify the server names and/or IP address from initial un-encrypted portion of the exchanges used while establishing the secure connection [4—RFC 6066].
4. Identify the target domain name and behavioral category for a set of user flows: For HTTP content that is not encrypted, the URL is in clear and domain name is extracted per HTTP protocol. If the flows use HTTPS or TLS, and URLs will be in encrypted content and could not be identified. For such flows, domain names are determined from DNS Request/Responses that precede the encrypted content per prior art methods [Zettics Patents]. Once target domain is identified, a behavioral category is assigned to the domain (Ref Zettics Dynamic Learning patent). The behavioral category of the target IP Address/domain is used in identification and classification of the observed UUIDs into Ad-ID, App-Id and Cloud-ID.
5. Identify Ad-Id: Ad-Ids are transacted between applications on the mobile device and Publisher or Advertising servers. Once the target domain has been identified as belonging to one of these categories—either Content Publisher or Advertising, a shortlist of UUIDs seen by each subscriber to each of these sites is prepared. The shortlist is continuously updated as streams of correlated multi-dimensional data are received and processed. On pre-defined time boundaries (e.g. hourly and/or daily), captured UUID-data is consolidated for individual subscriber and confidence is assigned to each SubscriberId-UUID-Domain triad. This confidence data may be further aggregated and qualified with historical observations for that subscriber to generate fresh confidence levels.
6. Dynamic Learning and Aging out: As the system is first deployed and no IDs or associations are established, it starts from data collection to build the possible list of UIDs and the associated subscriber IDs, App Names etc., and after a period of learning validates IDs learnt to determine confidence levels—for example, for an ADID by Apple, the UUID string may be learnt from IDFA=32Hex Characters (per RFC4122); the confidence level for the said ID is increased when the same ID appears to multiple destination domains or the same tag, “IDFA=” is used by multiple I phones for traffic sent to the same site or multiple sites; after confidence levels are established the system may export the learned associations or may respond with mapping results via API. Subsequently the system continues to learn, validate and update the associations in a streaming fashion, and aging out or decreasing confidence levels of not recently used associations.
7. Increasing confidence level based on analytics user query—The analytics system per the current invention provides an API for the user to retrieve Subscriber-id to Ad-ID mappings. The user query could be, (1) to get subscriber id for an Ad-ID, or (2) to get plurality of Ad-IDs with different confidence levels for a given subscriber-id. In case (1) if an IMSI has 5 ad-id candidates, and user queries with one ad-id to get subscriber id for that ad-id, increase the confidence level for that ID.
8. Multiple Tags in URL prior to UUIDs or Post UUIDs, increase weights for TAG & UUID it used by multiple sites. Thus IDFA/ADID extracted by a server via HTTPS with encryption, and later used by UE to a different site, the UUID and TAG could appear deeper in the URL string and not close to characters (=,? etc.). Similar methods for APPID.
9. App-id Use cases: The App-id to IMSI, domain name etc., facilitates determining APP use counts (# times), use minutes, ad-count (number of ads during app), app-delay metrics (start delay 1^{st} (from DNS to delivery of 1^{st} app-bytes), ad-delay metrics)—intent is to compute “blank/spin—time for app”, “lost ad opportunities”, number of unique IMSIs for each app, app behavior on different mobile devices etc. and benefits the app vendor.
10. Identify Cloud-ID: Publisher content servers may be virtual and hosted by cloud environments such as Amazon's AWS, or Google Cloud or even CDNs like Akamai etc. In such cases, the domain names identified in Step 3 above would correspond to the cloud provider (such as Amazon) or CDN (e.g. Akamai) and not the Publisher server that is being targeted by the mobile device. The Cloud or CDN environment uses a unique identifier (termed Cloud-Id in the current invention) to uniquely identify the Publisher whose content is being served. The Cloud-Id represents this unique ID and is associated with Subscriber-Id to understand the subscriber activity. The Cloud-Id for a set of user flows can be identified from un-encrypted portions of the flows.
11. Identify CD N-ID: Application servers may have partnership with CDN provider to host, cache, and serve their content to minimize client to server latencies, and improve response times. In this case the server IP Address and/or domain/server names correspond to domain names/server names/ip-addresses of CDN provider and not origin servers. The CDN provider uses additional names and/or identifiers that corresponds to a specific origin server and use that in mapping UUIDs to ad-ids or app-ids using http tag fields together with domain/server names.
12. Identifying user generated URL requests and differentiating with background or web-page generated requests, for example for advertisements, by identifying significant gaps, top level requests etc.

6.1. Ad-ID to Subscriber ID Mapping

Subscriber ID to Ad-Id is performed in 3 steps:
1. Data collection phase: gather UUIDS, corresponding subscriber ID, domain/server/ip-address, query tags
2. Assign confidence levels for each UUID & tag depending on behavioral category of the domains/servers used and frequency of use of that UUID & tag used for every subscriber
3. Delete aged-out and low confidence levelIDs
4. Update tables with new data

6.2. Ad-Id Algorithm Version 1

Ad ID seen in URL generally look like
http://host.com? key=junk . . . & keyword=xxxxxxxx-xxxx-xxxx-xxxx-xxxxxxxxxxxx . . .
Where “x” is hex char (upper or lower case)
May be first parameter (after“?”) or subsequent (after“&”)
May use “%3D” instead of“=”
May be more than one parameter of this form per URL, so have to check them all
Ad ID form is generally (always?) RFC-4122 compliant
version 1 (time/node based): xxxxxxxx-xxxx-1xxx-Rxxx-xxxxxxxx
version 4 (random): xxxxxxxx-xxxx-4xxx-Rxxx-xxxxxxxx
“R” is 8, 9, A, or B, since the top two bits as “10” indicated RFC-4122 compliance
We have only observed version 1 and 4, RFC-4122 Ad IDs, so far.
Type-1 includes a 6 byte MAC address and 60-bit timestamp. The type-1 timestamps we have observed are generally distributed within the previous year (indicating that Ad ID lifetime is probably <1 year).
We haven't analyzed MAC addresses, or whether ID version depends on OS or device type.

Type 4 includes a 122-bit random value and nothing else.

### Algorithm

### Step 1

Using Hadoop, search all available HTTP records for every query parameter that has the right form (UUID),

save the subscriber, domain, keyword name and potential Ad ID, and aggregate all (subscriber|adid) pairs seen with each (domain|parameter) pair:
imrworldwide.comlts 9781234567|d7267c6f-6f35-4b51-9eaf-41333100ef66,7815551212|d7267c6f-6f35-4b51-9eaf-41333100ef66
radiotime.com|idfa 9784443232|510f3788-637f-4469-8858-44968c5d4642
artofclick.com|google_aid5085235532|50556478-3db9-405a-a267-28b07202b2ee, 7815551212|d7267c6f-6f35-4b51-9eaf-41333100ef66,

### Step 2

For every domain/query parameter name from step 1, create a set of all the subscriber/Ad ID pairs, discarding any problematic ones (e.g. ones that use“;” to delimit additional sub-parameters within the query parameter), then determine if there is approximately one unique Ad ID for each unique subscriber. If not, discard the data for that domain/query parameter. (see one-to-one analysis later).

### Step 3

Take pairwise combinations of the records from step 2. Each record is identified by a (domain/qp) and contains a list of (subscriber|adid) pairs. For each pair of records, combine their subscriber ladid pairs and test if the combined data is still sufficiently one-to-one, i.e. they don't disagree about which subscribers go with which adids. Only combine records where both patterns see the same subscriber, or both patterns see the same Ad ID. If they match each other, put them in the same group. Keep adding to the various groups as new pairs are analyzed, assuming that if A^{˜}B and A^{˜}C, then A^{˜}B^{˜}C.

### Step 4

Once the groups are determined, combine subscriber/adid pairs for entire group and check one-t o-one. Print out each group and its one-to-one parameters. Typically, one group should stand out by containing a large number of query parameters, and having good statistics. This is the desired group of patterns. As a check, we also combine a few of the final groups to see if the results could be improved. Typically, this will only help if the amount of records analyzed in step 1 was too small.

### One-to-One Correspondence

Ideal: one adid per subscriber. 3 subscribers, 3 adids, 3 mappings.

### Subscriber 1 Adid A

### Subscriber 2 Adid B

### Subscriber 3 Adid C

Error formulas:
adid/subscriber error=(mappings/subscribers)−1;
subscriber/adid error=(mappings/adids)−1
   Some errors. 3 subscribers, 4 adids, 5 mappings.
   Adid error=(5/3)−1=66%. Subscriber 1 mapped to 1 adid; subscribers 2 and
   3 each mapped to 2. The average subscriber is mapped to 1.66 adid.
   Subscriber error=(5/4)−1=20%. The average adid matches 1.20
   subscribers.
   Subscriber 1 adid A
   Subscriber 2 adid B
   Subscriber 2 adid C
   Subscriber 3 adid A
   Subscriber 3 adid D

### One-to-One Error Estimates

The one-to-one function returns four error parameters. The first two are (mappings/subscribers)−1 and (mappings/adids)−1, as described in the one-to-one discussion. These are no longer used due to the fact that they would indicate that 100 mappings with 100 adids (0% error), was just as good as 1 mapping with 1 adid (0% error).

The second two parameters are the same adid and subscriber error parameters with an effort to apply bayesian statistics, which integrates the chance of seeing the observed result over all the possible probabilities. Effectively, the smaller the sample size, the more the error is adjusted. So, 100 mappings with 90 adids would be considered 90 successes with 10 failures to have a unique adid.

Strict division would say the success rate was 90%, but the bayesian success probability is 89.2% (pretty close, since the sample size is kind of high). But for a smaller sample, say 9 successes and no failures, rather than 100% success, we get about 90.9%, indicating that 9 out of 9 scores about the same as 90 out of 100. There are other ways to de-empathize smaller samples (most simply, by discarding them). But this seems to work well especially when the dataset is small and we can't afford to discard data.

The format of the output is the set of (‘domain’, ‘query parameter’) pairs considered part of the same group, followed by the four error estimates of the combined group: frequentist adid error, frequentist subscriber error, bayesian adid error, bayesian subscriber error. We use the bayesian, so for the first group, adid and subscriber error are 9% and 0.5% respectively. That indicates this is probably a meaningful ID within that group of domains, but does not match the real group (which is not shown). The other two groups have errors of 2.7% and 0.4%, and 9.3% and 1.9%. Probably locally meaningful, but not global IDs. The “real” group contained 143 patterns and had errors of 6.2% and 0.4% across all patterns.

Patterns for the “real” group

‘56txs4.com’,‘deviceAndroidid’
‘acekoala.co, ‘gaid’
‘adctioninteractive.com’,‘google_aid’
‘adactioninteractive.com’,‘ios_ifa’
‘adadvisor.net’,‘visitor_id’
‘adkmob.com’, ‘gaid’
‘adknon.com’, ‘ei’
‘adnxs.com’, ‘aaid’
‘adnxs.com’,‘idfa’
‘adsrv247.com’,‘aid’
‘adsrv247.com’, ‘idfa’
‘adsymptotic.com’,^{’}^{., 1}
‘advertising.com’,‘nielsen_devid’
‘aerserv.com’, ‘ adid’
‘aerserv.com’,‘oid’
‘algovid.com’,‘appaid’
‘algovid.com’, ‘appidfa’
‘algovid.com’,‘deviceid’
‘altitudeplatform.com’,‘adv_id’
‘amazon-adsystem.com’,‘idfa’
‘amazonaws.com’,‘did’
‘amobee.com’, ‘androidaid’
‘angsrvr.com’, ‘ang_appid’
‘angsrvr.com’, ‘ang_ifa’
‘anydiscounts.com’,‘gaid’
‘anydiscounts.com’,‘idfa’
‘appeverhave.com’, ‘cad[device_androidid]’
‘appeverhave.com’, ‘pub_domain’
‘appia.com’, ‘aaid’
‘applovin.com’, ‘idfa’
‘appmobile2424.com’, ‘cad[device_ifa]’
‘apprevolve.com’, ‘deviceld’
‘appsflyer.com’, ‘advertising_id’
‘apptap.com’, ‘did.aa’
‘apsalar.com’, ‘aifa’
‘apxadtracking.net’, ‘device_id’
‘bfmio.com’, ‘idfa’
‘bigappserver.com’, ‘gaid’
‘bigappserver.com’,‘idfa’
‘bluekai.com’,‘adid’
‘bluekai.com’, ‘phint’
‘bluetrackmedia.com’,‘advertising_id’
‘bluetrackmedia.com’,‘google_aid’
‘bluetrackmedia.com’, ‘idfa’
‘bnmla.com’,‘vadvid’
‘bnmla.com’, ‘vidfa’
‘btrll. com’, ‘ br_dpidu’
‘castplatfom.com’, ‘deviceld’
‘dashbida.com’,‘db_aid’\grave{ }
‘dpclk.com’,‘device_id’
‘duapps.com’,‘goid’
‘edmunds.com’, ‘edwedck’
‘edmunds.com’,‘uO’
‘flashtalking.com’, ‘ft_id’
‘fqtag.com’, ‘gid’
‘glispa.com’, ‘m.gaid’
‘glispa.com’,‘subid2’
‘glispa. com’, ‘subid5’
‘goforandroid.com’,‘adid’
‘greystripe.com’,‘gaid’
‘imrworldwide.com’,‘c9’
‘inmobi.com’,‘misc’
‘inner-active. mobi’, ‘aaid’
‘innovid. com’, ‘deviceid’
‘innovid.com’,‘ivc_deviceid_raw’
‘intertags.com’,‘ext_c_id’
‘iqm. com’,‘ devid’
‘jamloop.com’,‘userid’
‘kakao. com’, ‘adid’
‘king.com’,‘googleAdid’
‘king.com’,‘googleAdld_raw’
‘kochava.com’,‘device_id’

Observations from Interface Data (PCAP) with Sample Tests on Previous Algorithm:
(1) On Bluekai.com, there are references with “phint=”, “phint=idfa=:, “adid=”=, or “idfa=”. The settled-on tag includes “phint=adid”, and “phint=id”, and does not include “idfa=”. Looks like this tag being discarded in Steps 2, 3.
(2) “Bidswitch.com”, has many consistent UUID reference with tags, “li_uuid=”, and “user_id=”. The UUIDs with tag=li_uuid” are consistent with each IMSI; however, the value with “user_id=” are not consistent (same IMSI, multiple values. Thus the “li_uuid” seem to refer to IDFA. However, “in the list of “domain-tag”, identified “bidswitch does not exist”. Looks like the validation may be removing them. The algorithm could be improved by associating the tag names persistent on a site where the Corresponding UUIDs remain persistent for each IMSI”. These changes are incorporated in the following improvements.

### Algorithm Improvements:

(1) Gathering UUID—Step 1:
   (a) Do not consider the RFC4122 complaint Hex Character string as candidate if the end of the string has, “.”, “_”, “-”. The reason for this is many content & object ids are filenames, and files will have those characters. This reduces UUID set for a user, and error rate.
   (b) in some cases (when UUID is passed by one site to another, the 32 characters may appear without “-”. However recognizing this would require finding 32 HexCharacters with Version 1 & 4 patterns and Terminating “non Hex Characters that are not “.”,“_”,“-”.
(2) IDFA string in URL with 32Hex Characters matching Version 1 & version 4, with hyphenated (8-4-4-4-12), all escape sequences converted, pre fields such as= or mid“-”.
(3) IDFA with 32 Characters (version1 & 4) no field separators (- or % xx), i.e. 32 Hex characters with leading and trailing non-Hex Characters
(4) Same as (2) without the “IDFA” in the URL string; the 32 Hex Characters match Version1 &Version-4 patterns (irrespective of separators—or escaped version).
(5) The above will give many UUIDs for 1 IMSi—select those that is same for 1 IMSI to two multiple destination domains—same 32 Hex Characters for 2 different domains—1 validator. 2nd Validator, same 32 Hex characters appear for same at 2 different times (time difference greater than 1 Hour and the 2 sessions aredifferent).
(6) In (4) above, allow leading matches for an already acquired UID—for example, if 2 UIDS, “abcdefgh-1234-5678 . . . ”, and “ijklmnop-1234-5678 . . . ” are potential candidates for a UE, and the strings “ijklmnop” appear for terminated URL string appear from a different domain, validate “ijklmnop”. The reason for this is, in some cases, the URL strings are cut short due to 1 site passing on to other sites.
(7) The above could give more than 1 ADID per IMSI—strong validator with previous algorithm+ ADID to IMSI query by Operator—i.e, if an IMSI has 3 candidate UIDs (a1 . . . a3), and Operator queries with a2, a2 is marked as a valid ADID.
   Unlike the current method where there is strong dependency on domain & tag, the above has no strong dependency on domain & TAGs. While it increases coverage, it could decrease accuracy; this could be reflected as another metric, “confidence interval”.
   By the way, since the above methods could increase CPU cycles, and could increase storage space for keeping multiple ids, possibly the benefit of each step could be characterized (similar to considering “IDFA” string) first before adopting it.

### 6.3 ADID Algorithm Version 2

1) collect for each domain/query parameter a set of (subscriber, uuid) pairs from clickstream data
2) filter out domain/query parameter tuples which don't comply with the following constraints
a) at least MIN_SET_SIZE (subscriber, uuid) tuples are associated with the domain/query parameter
b) % of subscribers with multiple uuids<=ERR_1
c) % of uuids with multiple subscribers<=ERR_2
   3) for each uuid, create a list of subscribers and a list of (domain, query parameter) pairs
   4) scan for uuids mapping to more than one subscriber and create uuid and (domain, query parameter) blacklists
   5) for each subscriber, create a list of (uuid, (domain, query parameter)) pairs
   6) for each subscriber, vote for the uuid most likely to be the advertising id

### Voting Process Per Subscriber:

1) remove blacklisted uuids and (domain, query parameter) tuples
2) for each uuid, count the number of associated ‘query parameters’ that match well known tags for advertising id.
3) if there were no uuids associated with at least MIN_QP well known tags then declare the election invalid and move to next subscriber
4) the uuid with the most votes is now declared the winner
5) each (domain, query parameter) that voted for the willing uuid is given a win
6) each (domain, query parameter) that voted for to losing uuid is given a loss
7) discard any (domain, query parameter) tuples that had a election loss %>MAX_PCT_ELECTION_LOSS. The remaining set (domain, query parameter) tuples are declared to be credible sources for advertising id.

The above process can be done offline periodically, or continuously with a stream of clickstream records.

The running system will maintain the most likely advertising id for each subscriber. When a new uuid is observed for a subscriber from a set of credible tuples (domain, query parameter), the new uuid is promoted to be the advertising id.

When a new, non-blacklisted, (domain, query parameter) tuple is observed with at least MIN_VOTES subscribers and its election loss percentage is <MAX_PCT_ELECTION_LOSS, the new (domain, query parameter) tuple is promoted to credible status.

When an existing credible (domain, query parameter) tuple loss percentage exceeds MAX_PCT_ELECTION_LOSS for a period, it is demoted from credible st at us. If its loss percentage stays above the MAX_PCT_ELECTION_LOSS for a period of time, the tuple is put on the blacklist.

### 6.4 Differentiating Browser & Native-App Accesses

When a mobile device communicates with servers on the internet (cloud, origin server or DCN), the application on the device may be browser (Safari, Firefox, Internet Explorer, Chrome etc.), or a native application that is downloaded and running on the device. Applications may also use HTTP or HTTPS protocol and may not be distinguishable based on TCP/IP port numbers alone. Also, several browsers integrate search engine. Thus, when a user enters a string into browser tool bar the string is sent to the default search engine that the browser uses, which returns search results; user then selects some sites/links within the search results. This generate access pattern in the user flow data as TCP (HTTP or HTTPS) connection with small uplink traffic, followed by a downloaded page, followed by a sequence of DNS Requests and TCP connections to other domains. Such a dataflow pattern identifies Search+Browser based user accesses. The following steps differentiate between Browser & Non-Browser (Native Applications) based Accesses from a user device:
1. TCP Port numbers That are not HTTP or HTTPS or QUIC are non-browser accesses.
2. When the Port Numbers correspond to HTTP (80, 8080 etc.) or HTTPS or QUIC, the underlying applications may be browser or non-browser.
3. HTTP User Agent string generally contains browser identity such as SAFARI, IE and corresponding Version. However, these strings may be modified and could be used by applications. Since most users do not modify default strings used by browser, selecting user flows from large number of user devices of same device type, for example i-phone 5, and selecting the dominant user-agent string, most likely corresponds to the native browser flows.
4. The access flow patterns for the browser flows identified in step 3, and determining, (a) Number of simultaneous TCP connections to the same server (FQDN), (b) Number of simultaneous TCP connections to any domain, (c) TCP connection hold time (how is the TCP connection is maintained by the browser after data transfer is complete, (d) 1^{ST} domain access after an idle time, (e) HTTP Pipelining support (overlapped HTTP Requests to the same server etc.
5. Labelling the user access flows identified in Step 3 as “Browser-A”, and using the attributes identified in Step 4 facilitates training Supervised Clustering algorithm to differentiate between browser and non-browser access patterns. The trained model could then used to distinguish between Browser & Non-Browser Accesses.

### 6.5 Identifying Unique Identifiers as App-Ids

Some of the unique identifiers extracted from user flows may correspond to application unique identifiers (AppID) that are unique to the specific device type or appstore, for example, i-phone/AppStore may use one format of IDs, and Android a different format. For example, AppIDs by Apple use the format:

A1B2C3D4E5.com.domainnam.e.appname, where, the string “A1B2C3D4E5” is apple assigned, and “com.domainname.appname” is developer assigned, and the two together is termed “AppId”.

After browser accesses are filtered from HTTP/URL flow records, for each device type, domain name, UIDs & associated tags are maintained similar to Ad-Ids in section 6.1. For each UID confidence level is maintained that indicates the probability that UID is an AppID. When a UID is associated with tag-name=“appid” in URL string, confidence level is set to 100%. For each subscriber-id, flows are grouped as sessions based on multi-second idle times. Thus, a user's session may have HTTP, HTTPS, DNS etc. flow records and UIDs & tags will be visible in HTTP URL records.

Thus AppId is the ID for all the flows in that session. When user activates an app on the mobile, it's majority of communication, by volume and/or time duration will be with the webserver. Thus, for each user session, dominant domain names are tracked. If a UID appears in sessions of multiple users, and the dominant domain names (FQDNs) in those sessions are same, that UID is likely to be an Application ID, and the associated confidence level is increased. UIDs with confidence levels greater than 60% are marked as Application IDs. The data collection & analytic system, characterizing application behavior from observed sessions with same ApplicationId.

### 6.6 Identifying Underlying Content Provider/Brand of CDN Traffic

CDNs use a variety of techniques to steer traffic away from the original website (brand/publisher) onto the content delivery network. These techniques include URL rewrite, HTTP redirection, DNS redirection, and anycast. The method outlined uses a stream of HTTP(S)/URL flow records, a URL classification function, and a list of known CDN URL patterns. It is assumed that the source of the http records will record domain observed from DNS monitoring for https traffic.

The HTTP records are sorted in ascending time order and inspected on a per subscriber level. Each http record is classified according to its URL into a category and subcategory. Categories include ‘Advertising’, ‘Analytics’, ‘CDN’, ‘Software APIs/Service’, etc. Once classified, the record is dropped if it is determined not to be associated with a publisher/brand (Origin Server). For example, ‘Advertising’, ‘Analytics’, ‘Software APIs/Service’. If the record is not associated with a known CDN, then associated brand is captured as the ‘current’ brand for this user. If the record is associated with a known CDN pattern and there is not yet an underlying brand associated with this CON, then the current CDN pattern is associated with the ‘current’ brand and a ‘vote’ for this cdn/brand association is emitted and forwarded using the CDN pattern field as key. If the record is associated with a known CDN pattern as well as a known publisher, the record is dropped.

Once all of the ‘votes’ have been cast for a particular CDN pattern, the next stage of the learning process counts the votes and sorts them in descending order. If there is a clear winner according to the vote count (e.g. 95% of votes), number of unique candidates (e.g. less than X), overall number of votes cast (e.g. greater then Y), bytes/hits observed for the current CDN pattern, then the winner is declared to be the associated brand/publisher for this CDN pattern and the categorization database is updated.

During the election process, if a CDN pattern is found to be associated with an excessive number of brand candidates, each containing a significant vote count, then the URL will be reclassified with a category that is not associated with a publisher/brand and the categorization database will be updated.

Once the CDN association process completes and the current categorization database is updated, the process can be repeated with the same or a different set of data one or more times to increase accuracy of the learning result. A ‘time of learning’ is associated with each learned relationship and can be used to trigger re-verification of previously learned relationships or to remove mapping that have not been observed for a configurable period. The learning process is intended to be run periodically to update the learned relationships.

The intention of the process is to automatically learn the relationship between a CDN provider URL and the underlying content/brand (publisher). The process outlined removed the noise (ads, analytics, software api/services, etc) from the input stream to make the signal (brand/CDN association in time) stronger. This technique employs the effect of the law of large numbers by observing traffic patterns from a very large number of subscribers over space and time to filter the incoming signal.

### 7. USE CASES

This section describes specific use cases for each of the Ids extracted.

### AdId Use Cases:

The AdID or IDFA uniquely identifies a mobile device for delivering mobile advertising. The mobile advertising ecosystem including the mobile applications to the mobile ad delivery and analytics uses the IDFA for ad delivery, tracking and performance tracking purposes. The AdId is transmitted from mobile devices to remote advertising servers as a parameter on HTTP and in some cases HTTPS advertising calls and can be extracted through mobile traffic elements.

Further, the network providers uniquely identify their own subscribers using a hashed version of their own SubId. The SubId or a hashed derivate of this SubId is used by the network providers to transmit/route traffic to/from internet, bill the subscriber for mobile usage. The SubId (or its derivative) remains static over the life of a mobile device. This enables identification and inference of mobile behaviors & the user demographics of the individual mobile devices connecting to the network. The mobile behaviors are extremely valuable for targeting the right mobile advertising to individual mobile devices.

By identifying and extracting AdIds from mobile advertising traffic in particular, correlating them to SubId, and then associating it to historical mobile behaviors & User demography from a mobile device, network providers can leverage AdIds for monetization of mobile traffic flowing through their network elements in the mobile advertising ecosystem. Thus, the AdId to subscriber ID mapping:
1. Enables monetization of subscriber's behavioral data within the Operators' network in the open ad-ecosystem by identifying Ad-Id of the subscriber used in the mobile ad-ecosystem.
2. Enable holistic modelling of subscriber's behavioral data for Marketing and Advertising purposes by linking subscriber's behavior within the Operator's network with the behavior outside of Operator's network.
3. Enable tracking or measurement of advertisements to subscribers when the subscribers are connected to the Operator's network.

### APP-ID Use Cases:

1. Learn app-behavior when active by each user (duration, network up/dn usage, gaps, number of TCP connections, number of users (for example chat, games etc.), classification per EDFA (message, browsing, Video, Audio, game etc.); fit a model based on a number of users' app-usage
2. Enable comparison of application usage across different device ecosystems, device classes.
3. Determination if the users actually use the applications that are downloaded and compare usage across Appstore ecosystems.
4. Enable recommendation of Applications based on presence or absence of downloaded applications
5. Anomaly detection—Benefits: Adverse Usage for example if app infected by threat, miss-usage; behavior change by new release.
   Cloud—Id: A Cloud—Id has the following potential uses:
1. Identify the Publisher that the Cloud delivered content belongs to and derive subscriber behavior
2. Identify and compare content delivery of similar content types from various Cloud Providers and offer insights & recommendations based on these rankings. Operators could deliver the insights to Content Publishers and/or Cloud Service providers.

### CDN Resolution Use Cases

1. CDN resolution identifies the Publisher delivering the content to the subscribers and hence is instrumental in improving identification of subscriber behaviors for monetization through better ad serving.
2. Identify and compare delivery of content from various Publishers through each CDN and offer recommendations to CDN vendors and content publishers based on these rankings.
3. Compare key performance metrics between CDN delivered and Publisher delivered content for similar content types to assist CDN growth
4. Orchestrate Mobile Edge Content delivery by estimating the KPI improvements relative to CDN placements.

1. A data collection system that receives plurality of user network data access flows that include HTTP/HTTPS URLs from network probes or network elements such as CDNs, Proxies, control plane logs (S11, S1AP etc.) that include permanent subscriber identifier (IMSI, IMEI) or obfuscated subscriber identifiers, or obtains such identifiers corresponding to user IP addresses in access flows from operator network elements, extracts plurality of unique identifiers (UUIDs), plurality of tags, or contextual identifiers that appear in URL strings, determines domain names from HTTP/HTTPS header fields or temporally close DNS flows and generates a mapping table that includes subscriber identifiers, domain names, HTTP tags, and associates subset of UUIDs as potential Advertisement Identifier (Ad-Id) for each subscriber-id based on the usage counts of that UUID across multiple domains.

2. Selecting a small set of UUIDs from the mapping table in claim 1 based on use count by a subscriber-id in recent flows across multiple domains.

3. Exporting the subscriber-ID to Ad-ID mapping information generated in claim 2 to other operator network elements so that they could determine Subscriber-id corresponding to an Ad-Id in click-stream data for targeted advertisements.

4. Presenting an API for the mapping table in claim 2 to facilitate retrieval of subscriber ID for a given Ad-ID or plurality of Ad-IDs with different confidence intervals for a given subscriber-ID.

5. Increasing the confidence interval for Subscriber-ID to Ad-ID mapping when the external query in claim 4 is by Ad-ID.

6. Using the domain/publisher name and associated HTTP tags in the mapping table in claim 1 associated with most probable Ad-IDs with increased confidence intervals to increase confidence intervals for other subscriber-id to Ad-Id mappings.

7. The data collection system in claim 1 dynamically learning & selecting most probable Ad-Ids from plurality of UUIDs observed in click stream data and subsequently using them for follow-on time periods, and age-out unused IDs or discard IDs below a confidence level to reduce the number of ids; this auto-tuning accommodates UUID changes and uses both old and new IDs for a configured time period or based on usage count.

8. A data collection system that receives click stream data and subscriber information that includes HTTP/HTTPS/QUIK URL information, subscriber identifiers, such as IMSI, IMEI, or obfuscated subscriber identifiers, device types etc., and differentiates traffic from web-browser vs. native applications (non-browser), based on HTTP information elements, the number of simultaneous connections to the same site, number of simultaneous connections to multiple sites, number of websites accessed in a given user session, web-site access pattern, fully qualified domain name at the start of new session, learned browser behavior from similar set of device types etc., and uses the learned information to identify new user flows as browser vs. native applications in real-time.

9. The user session in claim 8 is identified as all the user flows between two significant time gaps where the time gap is chosen to reflect user idle time estimated from large number of user flows.

10. The web-site access pattern in claim 8 includes the first site accessed in a new session

11. The number of websites accessed in claim 8 excludes non-user-initiated requests such as advertisements.

12. A data collection system that receives plurality of user network data access flows that include HTTP/HTTPS/QUIK URLs from network elements such as probes, CDNs, Proxies, etc., extracts plurality of unique identifiers (UIDs), plurality of tags that appear in the proximity of the said UIDs, or contextual identifiers that appear in URL strings, determines domain names from URL fields or temporally close DNS flows and generates a mapping table that includes subscriber identities, domain names, HTTP tags, and associates subset of UIDs as potential Application Identifier based on the usage counts of that UID across multiple user devices of the same device family, to the same website; using the application identifier determined to group flow data from large number of users to characterize application behavior, and detect anomalies.

13. The website in claim 12 for determining UUID as Application Identifier is the first or dominant website in sessions of multiple users; thus, multiple users access the said website and the same UID appears in sessions of multiple users.

14. The anomaly detection in claim 12 includes learning application dataflow behavior of a number of flows over longer time period, fitting a statistical model, and using the model to determine anomalies of new flows from the same AppID in near Realtime.
